(19) United States
(12) Patent Application Publication
(10) Pub. No.: US 2008/0122952 A1
(43) Pub. Date: May 29, 2008

(54) ELECTRONIC CAMARA

(75) Inventor: Hiroaki Jodan, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 11/945,574

(22) Filed: Nov. 27, 2007

(30) Foreign Application Priority Data
Nov. 27, 2006 (JP) 2006-318138

(51) Int. Cl. H04N 5/262

(52) U.S. Cl. 348/240.3

(57) ABSTRACT

An electronic camera includes an imager. The imager has an imaging surface to which an optical image of an object scene passing through an optical lens is irradiated. A detector detects a high-frequency component of a partial object scene image belonging to an adjustment area out of the object scene image generated in the imaging surface. A changer changes the distance from the optical lens to the imaging surface step by step. An adjuster adjusts the distance from the optical lens to the imaging surface to an appropriate distance on the basis of the high-frequency component detected by the detector in parallel with the changing processing by the changer. A restarter restarts the changer by changing a size and/or a position of the adjustment area in response to an acceptance of an area changing instruction.

### CROSS REFERENCE OF RELATED APPLICATION

The disclosure of Japanese Patent Application No. 2006-318138 is incorporated herein by reference.

### BACKGROUND OF THE INVENTION

1. Field of the Invention

The present invention relates to an electronic camera. More specifically, the present invention relates to an electronic camera capable of adjusting the distance from an optical lens to an imaging surface on the basis of a high-frequency component of an object scene image captured by an imaging surface.

2. Description of the Related Art

According to the related art, a plurality of lens positions where a focus lens achieves a focus on a plurality of objects are detected. The position of the focus lens is changed to another lens position out of the plurality of lens positions when a position changing operation is performed after an autofocus operation. This makes it possible to easily obtain focusing on a desired object by the focus lens.

However, in a related art, the information of the plurality of lens positions to be referred are common through the position changing operation, so that accuracy of the focusing adjustment is reduced when the object is moved.

### SUMMARY OF THE INVENTION

The present invention employs following features in order to solve the above-described problems. It should be noted that reference numerals inside the parentheses and supplement show one example of a correspondence with the embodiments described later for easy understanding of the present invention, and does not limit the present invention.

An electronic camera (10) according to a first invention comprises: an imager (14) having an imaging surface to which an optical image of an object scene passing through an optical lens (12) is irradiated; a detector (30) for detecting a high-frequency component of a partial object scene image belonging to an adjustment area out of the object scene image generated in the imaging surface; a changer (S21) for changing a distance from the optical lens to the imaging surface to a designated direction; an adjuster (S27) for adjusting the distance from the optical lens to the imaging surface to an appropriate distance on the basis of the high-frequency component detected by the detector in parallel with the changing processing by the changer; and a restarter (S3) for restarting the changer by changing a size and/or a position of the adjustment area when an area changing instruction is accepted.

An imager has an imaging surface to which an optical image of an object scene passing through an optical lens is irradiated. A detector detects a high-frequency component of a partial object scene image belonging to an adjustment area out of the object scene image generated in the imaging surface. A changer changes the distance from the optical lens to the imaging surface step by step. An adjuster adjusts the distance from the optical lens to the imaging surface to an appropriate distance on the basis of the high-frequency component detected by the detector in parallel with the changing processing by the changer. A restarter restarts the changer by changing a size and/or a position of the adjustment area when an area changing instruction is accepted.

The change in the size and/or the position of the effective focus area changes the characteristics of the high-frequency component detected by the detector, and moreover changes the appropriate distance from the focus lens to the imaging surface. Thus, the distance from the focus lens to the imaging surface is adjusted every time that a focus adjustment instruction is performed.

An electronic camera according to a second invention is dependent on the first invention, and the appropriate distance corresponds to a distance when an amount of the high-frequency component detected by the detector becomes maximum.

An electronic camera according to a third invention is dependent on the first or the second invention, and comprises: a setter (S7, S11) for setting the distance from the optical lens to the imaging surface to a plurality of distances; and a designator (S17, S19) for designating a change in direction by the changer on the basis of the high-frequency component detected by the detector in correspondence to each of the plurality of distances set by the setter.

An electronic camera according to a fourth invention is dependent on the third invention, and the direction to be designated by the designator is a direction in which the high-frequency component detected by the detector is increased.

An electronic camera according to a fifth invention is dependent on an invention according to any one of the first to fourth inventions, and the optical image to be irradiated onto the imaging surface corresponds to at least a part of the object scene in a surveillance zone, and further comprises a controller (36, 38) for changing a direction of the imaging surface to a desired direction.

A distance controlling program according to a sixth invention is a distance controlling program causing a processor (32) of an electronic camera (10) comprising an imager (14) having an imaging surface to which an optical image of an object scene passing through an optical lens (12) is irradiated and a detector (30) for detecting a high-frequency component of a partial object scene image belonging to an adjustment area out of the object scene image generated in the imaging surface to execute: a changing step (S21) for changing a distance from the optical lens to the imaging surface to a designated direction; an adjusting step (S27) for adjusting the distance from the optical lens to the imaging surface to an appropriate distance on the basis of the high-frequency component detected by the detector in parallel with the changing processing by the changing step; and a restarting step (S3) for restarting the changing step by changing a size and/or a position of the adjustment area when an area changing instruction is accepted.

A distance controlling method according to a seventh invention to be executed by an electronic camera (10) comprising an imager (14) having an imaging surface to which an optical image of an object scene passing through an optical lens (12) is irradiated and a detector (30) for detecting a high-frequency component of a partial object scene image belonging to an adjustment area out of the object scene image generated in the imaging surface, comprises: a changing step (S21) for changing a distance from the optical lens to the imaging surface to a designated direction; an adjusting step (S27) for adjusting the distance from the optical lens to the imaging surface to an appropriate distance on the basis of the high-frequency component detected by the detector in parallel with the changing processing by the changing step; and a restarting step (S3) for restarting the changing step by changing a size and/or a position of the adjustment area when an area changing instruction is accepted.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2(A) is an illustrative view showing one example of a panning rotation operation of an imaging surface;

FIG. 2(B) is an illustrative view showing one example of a tilting rotation operation of the imaging surface;

FIG. 3 is an illustrative view showing one example of a setting state of FIG. 1 embodiment;

FIG. 4 is an illustrative view showing one example of a distributed state of a focus area assigned to the imaging surface;

FIG. 5(A) is a waveform chart showing one example of a relationship between a position of the focus lens and a focus evaluation value;

FIG. 5(B) is a waveform chart showing another example of a relationship between a position of the focus lens and a focus evaluation value;

FIG. 6 is a flowchart showing a part of an operation of a main CPU applied to FIG. 1 embodiment;

FIG. 7 is a flowchart showing another part of the operation of the main CPU applied to FIG. 1 embodiment;

FIG. 8 is an illustrative view showing another example of the distributed state of the focus area applied to the imaging surface; and

FIG. 9 is an illustrative view showing a still another example of the distributed state of the focus area assigned to the imaging surface.

### DETAILED DESCRIPTION OF THE PREFERRED EMBODIMENTS

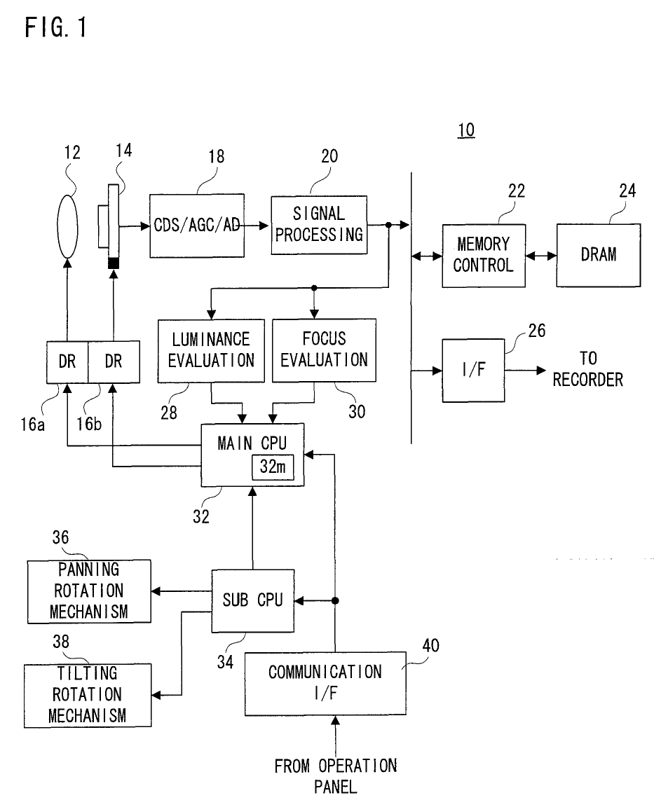

Referring to FIG. 1, a surveillance camera 10 of this embodiment is a dome-shaped camera set on a ceiling indoors for supervising a room from above, and includes a focus lens 12 and an image sensor 14. The optical image representing an object scene as a part of a surveillance zone is irradiated to the imaging surface of the image sensor 14 through the focus lens 12.

When a power is turned on, a main CPU 32 instructs a driver 16b to repeat an exposure operation and a charge reading operation. The driver 16b executes exposure of the imaging surface and reading of the electric charges thus generated in response to a timing signal generated every 1/30 seconds. Consequently, a raw image signal based on the read electric charges is output from the image sensor 14 at a frame rate of 30 fps.

An output raw image signal of each frame is subjected to a series of processing such as correlative double sampling, automatic gain adjustment and A/D conversion in a CDS/AGC/AD circuit 18. A signal processing circuit 20 performs processing such as color separation, white balance adjustment, YUV conversion and etc. on the raw image data output from the CDS/AGC/AD circuit 18 to generate image data in YUV format.

The generated image data is written to a DRAM 24 through a memory control circuit 22. A plurality of frames of image data is thus accumulated in the DRAM 24. The accumulated image data is read by the memory control circuit 22 and transferred to a recorder (not shown) through an I/F 26.

A luminance evaluation circuit 28 evaluates a luminance (brightness) of the object scene on the basis of Y data forming the image data of each frame, and applies an evaluation result, that is, a luminance evaluation value to the main CPU 32. The main CPU 32 calculates an optimum exposure period on the basis of the applied luminance evaluation value, and sets the calculated optimum exposure period to the driver 16b. Thus, the brightness of the image data accumulated in the DRAM 24 is adequately adjusted.

A communication I/F 40 fetches operation data output from an operation panel (not shown) in a surveillance room. The operation data has a panning rotation instruction, a tilting rotation instruction and a focus adjustment instruction as parameters. The panning rotation instruction and the tilting rotation instruction are applied to a sub CPU 34 while the focus adjustment instruction is applied to the main CPU 32.

The sub CPU 34 drives a panning rotation mechanism 36 according to a panning rotation instruction, and drives a tilting rotation mechanism 38 according to a tilting rotation instruction. The sub CPU 34 further detects a pan angle θp and a tilt angle θt at this time, and applies the detected pan angle θp and tilt angle θt to the main CPU 32.

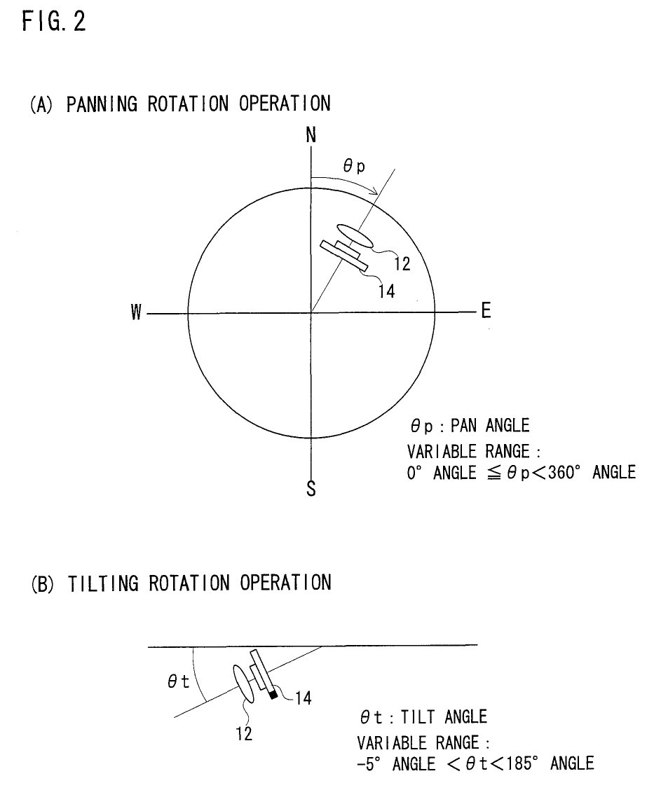

With reference to FIG. 2(A), the pan angle θp is a parameter for defining a horizontal angle of the optical axis being orthogonal to the imaging surface, and increases in a clockwise direction taking the horizontal angle when the imaging surface is oriented to the due north as 0° angle (or 360° angle). Accordingly, the pan angle θp indicates 90° angle, 180° angle and 270° angle respectively in correspondence with the due east, the due south and the due west. It should be noted that the variable range of the pan angle θp is 0° angle≧θp<360° angle.

With reference to the FIG. 2(B), the tilt angle θt is a parameter for defining a vertical angle of the optical axis being orthogonal to the imaging surface, and increases in the lower direction taking the vertical angle when the imaging surface is oriented to the horizontal direction with the upper end of the image sensor 14 above as 0°. The tilt angle θt indicates 90° angle when the imaging surface is oriented directly below, and indicates 180° angle when the imaging surface is oriented to the horizontal direction with the upper end of the image sensor 14 below. It should be noted that the variable range of the tilt angle θt is−5° angle<θt<185° angle.

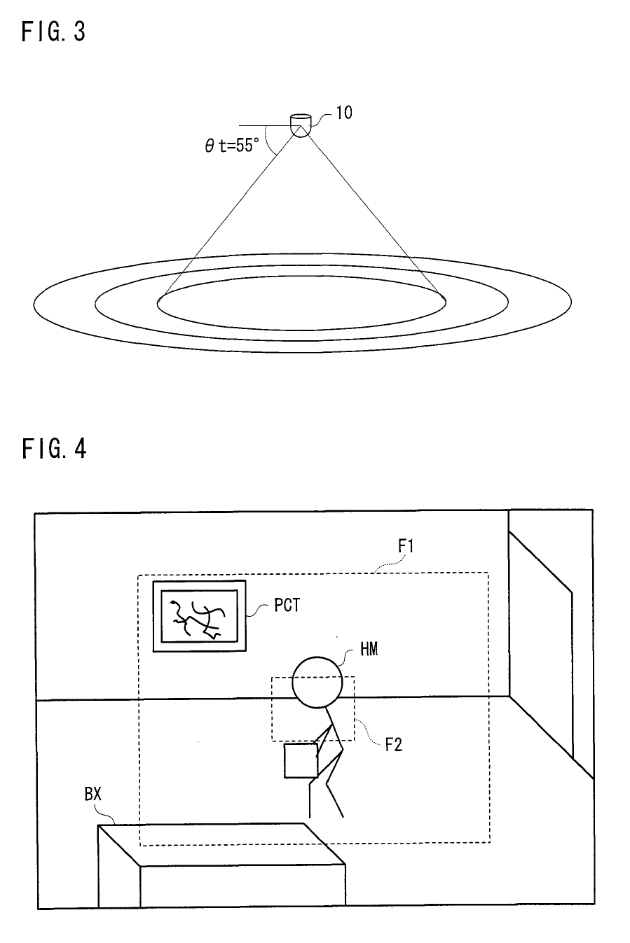

The surveillance camera 10 is set to the ceiling indoors as shown in FIG. 3, and supervises the room from above. When a panning rotation operation is performed in a state that the tilt angle θt is fixed, an intersection of the optical axis and a horizontal plane draws a circle. The center of the drawn circle corresponds with a position directly below the surveillance camera 10 (the center of the surveillance zone), and a radius of the drawn circle is increased as the tilt angle θt is decreased.

When a focus adjustment instruction is applied through the communication I/F 40, the main CPU 32 executes a focus control in a following manner.

At the center of the imaging surface, focus areas F1 and F2 having different sizes from each other are assigned as shown in FIG. 4. According to FIG. 4, the focus area Fl captures three objects such as a picture PCT hung on a wall, a human HM moving in the room and a box BX placed on the floor (although the box BX is partly captured), and the focus area F2 captures a part of the human HM.

The main CPU 32 first validates any one of the focus areas F1 and F2. The focus area F1 is validated in response to a focus adjustment instruction at an odd-numbered time, and the focus area F2 is validated in response to a focus adjustment instruction at an even-numbered time. The focus evaluation circuit 30 integrates a high-frequency component of partial Y data belonging to the validated Y data making up of the image data for each frame, and applies an integrated value, that is, a focus evaluation value to the main CPU 32.

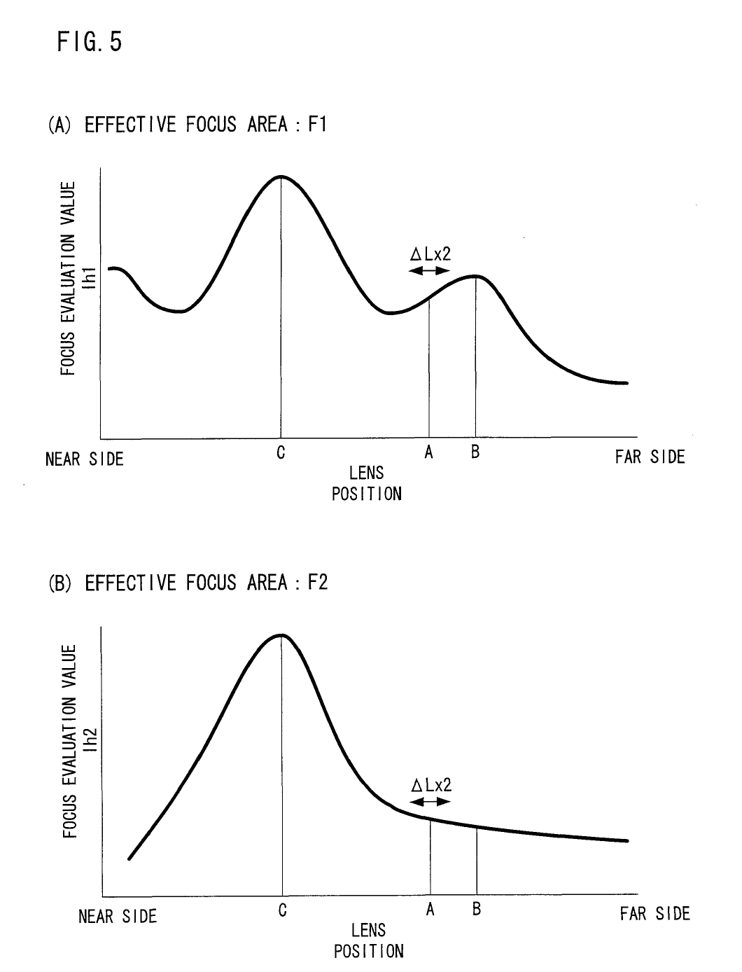

A focus evaluation value obtained in correspondence with the focus area F1 shall be defined as “Ih1”, and a focus evaluation value obtained in correspondence with the focus area F2 shall be defined as “Ih2”. In a case that the focus lens 12 moves from a near-side to a far side while noting the object scene shown in FIG. 4, the focus evaluation value Ih1 varies as shown in FIG. 5(A), and the focus evaluation value Ih2 varies as shown in FIG. 5(B).

The main CPU 32 moves the focus lens 12 in front and behind by the driver 16a by a slightly amount ΔL, and fetches focus evaluation values corresponding to the moved respective two positions 2 from the focus evaluation circuit 30. When the focus lens 12 is slightly moved in front and behanind a position A shown in FIG. 5(A) and FIG. 5(B), the focus evaluation value Ih1 obtained by noting the focus area F1 increases toward the far side while the focus evaluation value Ih2 obtained by noting the focus area F2 is increases toward the near-side. Thus, the main CPU 32 sets the moving direction of the focus lens 12 to the far side when the focus area F1 is validated, and sets the moving direction of the focus lens 12 to the near-side when the focus area F2 is validated.

After completion of setting the moving direction, the main CPU 32 moves the focus lens 12 in a set direction step by step by controlling the driver 16a, and fetches focus evaluation values from the focus evaluation circuit 30 in parallel with such lens moving processing. The main CPU 32 further detects a position where the fetched focus evaluation value becomes maximum as a focal point, and arranges the focus lens 12 at the detected focal point. Consequently, the focus lens 12 is arranged at a position B when the focus area F1 is validated while the focus lens 12 is arranged at a position C when the focus area F2 is validated.

Accordingly, when a focus adjustment instruction is issued twice through an operation by the operation panel in a state that the image sensor 14 captures the object scene shown in FIG. 4, and the focus lens 12 is arranged at the position A, a focus control by noting the focus area F1 is first executed, and a focus control by noting the focus area F2 is then executed. The focus lens 12 moves to the position B by the first focus control, and moves to the position C by the second focus control. That is, the focus is first achieved on the picture PCT, and then achieved on the human HM.

It should be noted that in a case that the human HM moves before and after the effective focus area is changed from “F1” to “F2”, the characteristic curve shown in FIG. 5(B) also changes. The focus control by noting the focus area F2 depends on the changed characteristic curve. In a case that the moved human HM still exists in the focus area F2, the focus is achieved on the moved human HM.

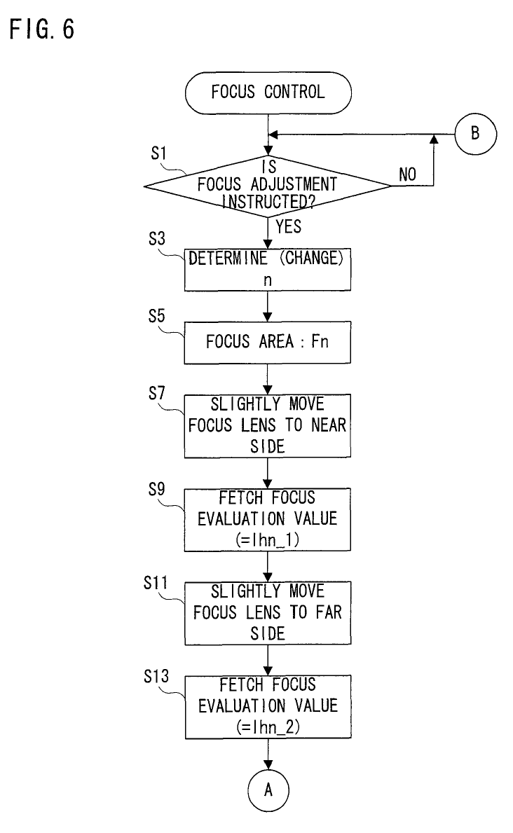

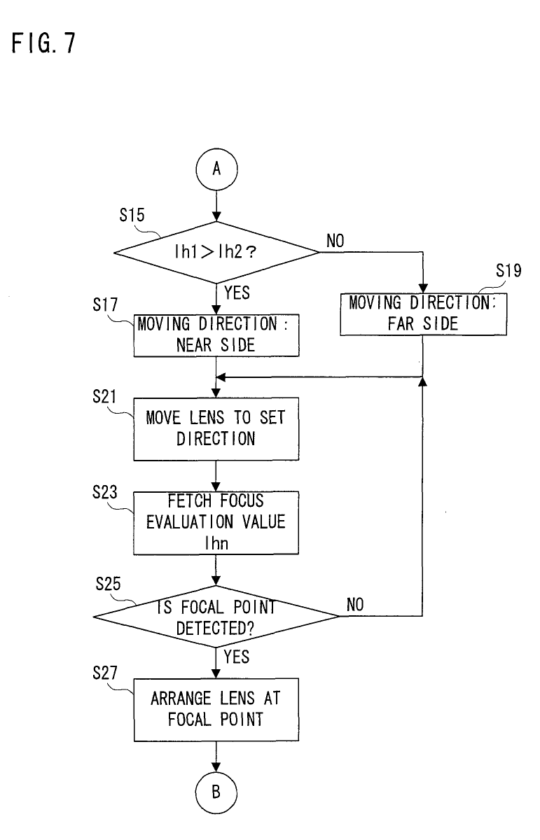

The main CPU 32 executes a plurality of tasks in parallel including a focus control task shown in FIG. 6-FIG. 7. It should be noted that the control programs corresponding to these tasks are stored in the flash memory 32m provided in the main CPU 32.

When a focus adjustment instruction is applied through the communication I/F 40, “YES” is determined in a step S1, and a variable n is determined in a step S3. The variable n is set to “1” in the processing in the step S3 at the odd-numbered time, and set to “2” in the processing in the step S3 at the even-numbered time. In a step S5, the focus evaluation circuit 30 is requested to create a focus evaluation value Ihn by noting the focus area Fn.

In a step S7, the focus lens 12 is moved by a slightly amount (=ΔL) to the near-side by controlling the driver 16a, and in a step S9, a focus evaluation value (=Ihn_{—}1) corresponding to the moved position is fetched from the focus evaluation circuit 30. In a step S11, the driver 16a is controlled to move the focus lens 12 to the far side by a slightly amount (=ΔL×2), and in a step S13, a focus evaluation value (=Ihn_{—}2) corresponding to the moved position is fetched from the focus evaluation circuit 30.

In a step S15, the focus evaluation value Ihn_{—}1 obtained in correspondence to the position on the near-side is compared with the focus evaluation value Ihn_{—}2 obtained in correspondence to the position on the far side. Here, when the relationship of Ihn_{—}1>Ihn_{—}2 is established, the process proceeds to a step S17 to set the moving direction of the focus lens 12 to the near-side. On the other hand, when the relationship of Ihn_{—}1 Ihn_{—}2 is established, the process proceeds to a step S19 to set the moving direction of the focus lens 12 to the far side.

In a step S21, the focus lens 12 is moved in the set direction by one step, and in a step S23, a focus evaluation value Ihn in correspondence to the moved lens position is obtained from the focus evaluation circuit 30. In a step S25, it is determined whether or not a focal point is detected on the basis of the focus evaluation value Ihn, and if “NO”, the process returns to the step S21 while if “YES”, the process proceeds to a step S27. In the step S27, the focus lens 12 is arranged at the detected focal point, and then, the process returns to the step S1.

As understood from the above, the image sensor 14 has an imaging surface to which an optical image of an object scene passing through the focus lens 12 is irradiated. The focus evaluation circuit 30 detects a focus evaluation value of a high-frequency component of a partial object scene image belonging to an effective focus area (adjustment area) out of the object scene image generated on the imaging surface. The distance from the focus lens 12 to the imaging surface is changed step by step by the main CPU 32 (S21). The main CPU 32 adjusts the distance from the focus lens 12 to the imaging surface to an appropriate distance (focusing distance) on the basis of the focus evaluation value detected by the focus evaluation circuit 30 in parallel with the changing processing of the focus lens 12. When receiving a focus adjustment instruction (area changing instruction) through the communication I/F 40, the main CPU 32 restarts a focus adjustment by changing the size of the effective focus area (S3).

The change in the size of the effective focus area changes the characteristics of the focus evaluation value detected by the focus evaluation circuit 30, and moreover changes an appropriate distance from the focus lens 12 to the imaging surface, that is, a focusing distance. Thus, the distance from the focus lens 12 to the imaging surface is adjusted every time that a focus adjustment instruction is performed. This makes it possible to easily change the object to be focused, and adjust a focus with high precision.

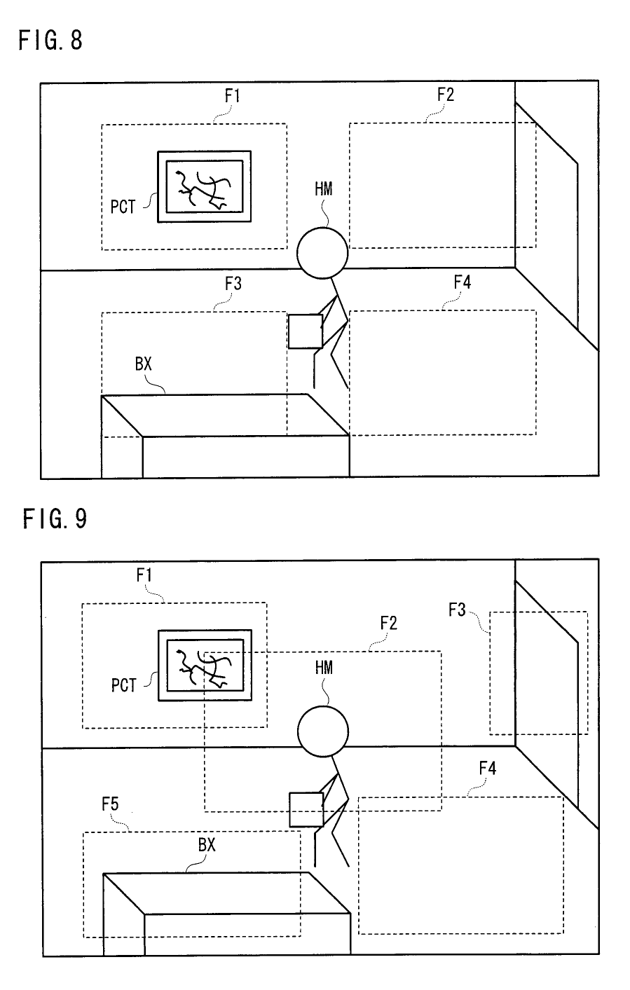

It should be noted that in this embodiment, the focus areas F1 and F2 having different sizes from each other are assigned to the same place on the imaging surface as shown in FIG. 4, but focus areas F1-F4 having the same sizes may be assigned to positions different from each other on the imaging surface as shown in FIG. 8, and focus areas F1-F5 having sizes different from each other may be assigned to areas different from each other as shown in FIG. 9.

Furthermore, in this embodiment, in the focus adjustment, the focus lens 12 is moved in the optical axis direction, but the image sensor 14 may be moved together with the focus lens 12 or in place of the focus lens 12 in the optical axis direction.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager having an imaging surface to which an optical image of an object scene passing through an optical lens is irradiated;
a detector for detecting a high-frequency component of a partial object scene image belonging to an adjustment area out of the object scene image generated in said imaging surface;
a changer for changing a distance from said optical lens to said imaging surface to a designated direction;
an adjuster for adjusting the distance from said optical lens to said imaging surface to an appropriate distance on the basis of the high-frequency component detected by said detector in parallel with the changing processing by said changer; and
a restarter for restarting said changer by changing a size and/or a position of said adjustment area when an area changing instruction is accepted.

2. An electronic camera according to claim 1, wherein
said appropriate distance corresponds to a distance when an amount of the high-frequency component detected by said detector becomes maximum.

3. An electronic camera according to claim 1, further comprising:
a setter for setting the distance from said optical lens to said imaging surface to a plurality of distances; and
a designator for designating a change in direction by said changer on the basis of the high-frequency component detected by said detector in correspondence to each of said plurality of distances set by said setter.

4. An electronic camera according to claim 3, wherein
the direction to be designated by said designator is a direction in which the high-frequency component detected by said detector is increased.

5. An electronic camera according to claim 1, wherein
the optical image to be irradiated onto said imaging surface corresponds to at least a part of the object scene in a surveillance zone, further comprising
a controller for changing a direction of said imaging surface to a desired direction.

6. A recording medium recording a distance controlling program, wherein
said distance controlling program causes a processor of an electronic camera comprising an imager having an imaging surface to which an optical image of an object scene passing through an optical lens is irradiated and a detector for detecting a high-frequency component of a partial object scene image belonging to an adjustment area out of the object scene image generated in said imaging surface to execute:
a changing step for changing a distance from said optical lens to said imaging surface to a designated direction;
an adjusting step for adjusting the distance from said optical lens to said imaging surface to an appropriate distance on the basis of the high-frequency component detected by said detector in parallel with changing processing by said changing step; and
a restarting step for restarting said changing step by changing a size and/or a position of said adjustment area in response to an acceptance of an area changing instruction.

7. A distance controlling method to be executed by an electronic camera comprising an imager having an imaging surface to which an optical image of an object scene passing through an optical lens is irradiated and a detector for detecting a high-frequency component of a partial object scene image belonging to an adjustment area out of the object scene image generated in said imaging surface, comprising:
a changing step for changing a distance from said optical lens to said imaging surface to a designated direction;
an adjusting step for adjusting the distance from said optical lens to said imaging surface to an appropriate distance on the basis of the high-frequency component detected by said detector in parallel with changing processing by said changing step; and
a restarting step for restarting said changing step by changing a size and/or a position of said adjustment area in response to an acceptance of an area changing instruction.
